(19) United States
(12) Patent Application Publication
(10) Pub. No.: US 2007/0247378 A1
(43) Pub. Date: Oct. 25, 2007

(54) Swing arm satellite assembly

(76) Inventors: Bobby Carl Masterson, Slaughterville, OK (US); William Edward Couts JR., Cauldwell, TX (US)

Correspondence Address: Jerry W. Anderson, 108 E. Main, Norman, OK, 73069, US

(21) Appl. No.: 11/177,016

(22) Filed: Jul. 9, 2005

Related U.S. Application Data
(60) Provisional application No. 60/586,957, filed on Jul. 10, 2004.

(51) Int. Cl. H01Q 1/32

(52) U.S. Cl. 343/713

(57) ABSTRACT

The invention is a economical, easy to use, device for mounting a dish satellite antenna onto a recreational vehicle, which is transferrable from one vehicle to another, economical, and enables the user to use either the front or rear mounting to enhance tv reception.

This invention claims priority from previous filed provisional patent application No. 60/586,957, filed on Jul. 10, 2004.

No federal funds were used in the development of this device

There is no microfiche appendix

### BACKGROUND OF INVENTION

This invention was conceived to address the problems of receiving satellite television signals for mobile recreational vehicles. This invention relates to the area of mobile satellite television antenna mounts. This invention is a simple device, which can be mounted on either the front or rear of the recreational vehicle as necessary, and can be rotated, by use of the swing arm, as to allow maximum signal reception. The invention can be easily transferred from one vehicle to another, is easy to use, and economical.

Recreational vehicle users have a need for a economical and simple device that can be used to tune in and receive satellite television signals easily and quickly. A common technique used previously is to mount the satellite antenna on top of the recreational vehicle, and to raise the antenna into position for receiving signals from inside the vehicle. Although this is a simple process to use, this requires extensive modification of the recreational vehicle, can not be transferred from one vehicle to another, and is expensive. Recreational vehicles are hereinafter referred to as RVs. The recreational vehicle that this device was mounted on is designed to be towed behind a truck or other powered vehicle, and has a rear bumper and a travel trailer tongue for towing.

There exists a need for an economical, easy to use, and transferrable satellite television antenna mount for recreational vehicles. In addition the present invention can be easily and quickly used by those not experienced in using and tuning satellite antennas.

An additional advantage of the described device is that the owner may have better reception of satellite TV signals. Instead of being limited to a location where the antenna mounted on the RV has a clear view the Southern sky, the owner needs only to have a clear view from either the front or the rear of the vehicle.

### DESCRIPTION OF PRIOR ART

Antenna mounts for television for mobile vehicles have been in use in for many years, with one of the earliest dating from 1950. Users of recreational vehicles have desired to be able to receive television signals for many years. With the advent of satellite television, which allowed viewers to get television in remote areas, vacationers purchased televisions for use in their recreational vehicles.

Inventors have tried similar combinations in the past, but their devices have lacked the ability to be transferrable from one vehicle to another, to be simple to use, enable the user to not be so dependent on a clear view of the Southern sky and to be economical. A clear view of the Southern sky is necessitated the satellite television. The satellite receiving the signal from ground stations and rebroadcasting to customers are in geo-stationary orbits aligned with the equator. Consequently, the satellites are in the Southern sky for the continental United States. If there are obstacles between the customer's receiver antenna and the satellite, the customer will not be able to watch television.

In May, 1987, Mr. Wilson was granted a U.S. Pat. No. 4,663,633, for a satellite television antenna mounting on a recreational vehicle, please note that this was prior to the present form of dish satellite TV, this was a very large antenna, approximately 6 feet in diameter, mounted on the roof of the RV, with a control to move the antenna into the upright position and another control to rotate the antenna for optimum reception. This device could not be transferred to another vehicle, absent extensive modification, and the RV had to be situated so that the antenna had a clear view of the Southern sky.

Similarly, in September 1996, Mr. Sherwood and Mr. Wagner, received a U.S. Pat. No. 5,554,998, for a roof mounted satellite antenna for RVs.

In September, 2000, Mr. Rogers was granted a U.S. Pat. No. 6,124,836, for a satellite television antenna mounting on a RV. This was similar to U.S. Pat. No. 4,663,633, in that the device was a roof mount, satellite antenna mount, for the dish type satellite. Again, this device could not be transferred to another vehicle, absent extensive modification, and the RV had to be situated so that the antenna had a clear view of the Southern sky.

In October, 1999, Mr. Coffield was granted a U.S. Pat. No. 5,961,092, for a dish satellite television antenna mounted on a semi-truck. This was a telescoping mount attached to the rear of the cabin of a semi-truck, during travel, the antenna was retracted below the top edge of the truck cabin, during use, when the truck was parked, the antenna was extended, and aligned with a satellite to receive television signals. The extension and alignment were done manually. The device did not have the versatility of the present invention, in that, the device was attached only to the rear of the cabin, thus limited parking to sites with a clear view of the Southern sky.

In March, 2004, Mr. Klienschmidt was granted a U.S. Pat. No. 6,714,170, for a device similar to U.S. Pat. No. 5,961,092, a dish satellite television antenna mounted on a semi-truck. In this device, the antenna raised and lowered, and aligned with the satellite by use of a motor, rather than manually. Again, the device did not have the versatility of the present invention, in that, the device was attached only to the rear of the cabin, thus limited parking to sites with a clear view of the Southern sky. For best reception, the satellite antenna must be aligned using both horizontal and vertical angles. In other words, the antenna mounting must be able to rotate the antenna, and to move the antenna up and down.

In January, 2001, Mr. Macon was granted a U.S. Pat. No. 6,175,339 for a retractable antenna clamp, which allows antenna to extend vertically, and to rotate, and mounts on vehicle, either RV, boat or camper. However this is not for satellite television reception, but general broadcast television.

Television antennas for vehicles, were granted in 1953 to Mr. Anderson U.S. Pat. No. 2,632,850, and in 1960 to Mr. Bailey, U.S. Pat. No. 2,941,204. These were for broadcast television not for dish satellite television.

In 2004, a patent for a Satellite RV stand, using a water filled base was granted to a Mr. Dierkes, U.S. Pat. No. 6,668,029. This did not have a transportation mode, and suffers from stability problems in severe weather.

In 2003, a U.S. Pat. No. 6,396,459 was granted to Mr. Pullman for a mount for attaching a satellite television antenna to a building.

In 2001, Mr. Pegues and Mr Hood, were granted a U.S. Pat. No. 6,195,066 for a extension arm for mounting a satellite antenna on a building to clear the eaves.

None of the previously described devices performs in the same fashion as the described device, enhancing the tv reception, transferrable, economical and easy to install and use.

### BRIEF SUMMARY OF INVENTION

This invention is a device for mounting a dish satellite antenna onto a recreational vehicle. Said device is economical, easy to use, and can be transferred from one vehicle to another.

When used in the conventional manner, the device allows the user to receive dish satellite television signals. The device can be attached to either the front of the RV, on the tongue, or to the rear of RV, on the rear bumper. The use of the front or the rear of RV, and the ability to extend and rotate, increases the versatility of the device. Previously, the RV had to be parked so as to allow a clear view of the Southern sky by the satellite TV antenna. Now, with the choice of front or rear, and the swing arm extension, the RV can be parked according to the availability, and not according to the vagaries of satellite TV reception.

If the need or desire arises, the entire system can be moved from one vehicle to another, by moving the front and rear brackets to the other vehicle.

### BRIEF DESCRIPTION OF DRAWINGS

FIG. 1. Side view of the swing arm satellite assembly, mounted on rear bumper bracket.

FIG. 2. Top view of described device showing rear bumper bracket and swing arm.

FIG. 3. Side view of the swing arm satellite assembly with satellite dish mounted.

FIG. 4. Top view of described device mounted on rear bumper bracket, showing range of motion, and storage/transportation position.

FIG. 5. Cutaway view of distal end of swing arm with satellite pole inserted.

FIG. 6. Side view of described device mounted on rear bumper bracket.

FIG. 7. Side view of front bracket showing both set screws.

FIG. 8. Interior view of front bracket showing set screw for attaching bracket to travel trailer tongue.

FIG. 9. Exterior view of front bracket showing set screw for attaching satellite pole to bracket.

FIG. 10 Top view of front bracket show both set screws.

FIG. 11. Top view of front bracket mounted on travel trailer tongue with swing arm and satellite pole installed.

FIG. 12. Side view of front bracket mounted on travel trailer tongue with swing arm and satellite pole installed.

### DRAWINGS LABELS

10 Rear bumper bracket
11 set screw in rear bumper bracket
12 U-bolts for mounting rear bumper bracket
20 Front bracket
21 set screw in front bracket to hold bracket to bumper
22 set screw in front bracket to hold swing arm in bracket
30 Swing arm
31 set screw in swing arm to secure satellite mounting pole
40 satellite mounting pole
50 satellite dish
60 back bumper
70 rear of travel trailer
80 travel trailer tongue
81 travel trailer hitch
90 front of travel trailer
100 storage/traveling position of swing arm

### DETAILED DESCRIPTION OF INVENTION

The invention herein is an economical, transferrable mounting for satellite television on a recreational vehicle. The device can be mounted on the front or rear of the vehicle, allowing the user to have more freedom in parking. The device comprises a front bracket 20, a rear bumper bracket 10, a swing arm extension 30, and a satellite mounting pole 40. The swing arm extension, and satellite mounting pole are free to rotate in the mounting brackets.

The aforesaid rear bumper bracket 10 is designed to mount the rear bumper of a RV. The rear bracket consists of a flat metal plate with a metal cylinder welded into the center of the bracket. The rear bracket has two U-bolts 12 that go underneath and around the rear bumper and attached to the rear bumper bracket by four nuts. The swing arm 30 is inserted into the metal cylinder and is freely rotatable through approximately 180°. The swing arm is secured to the rear bumper bracket by set screw 11. The rear bumper bracket is shown in FIGS. 1, 2, 3, and 4.

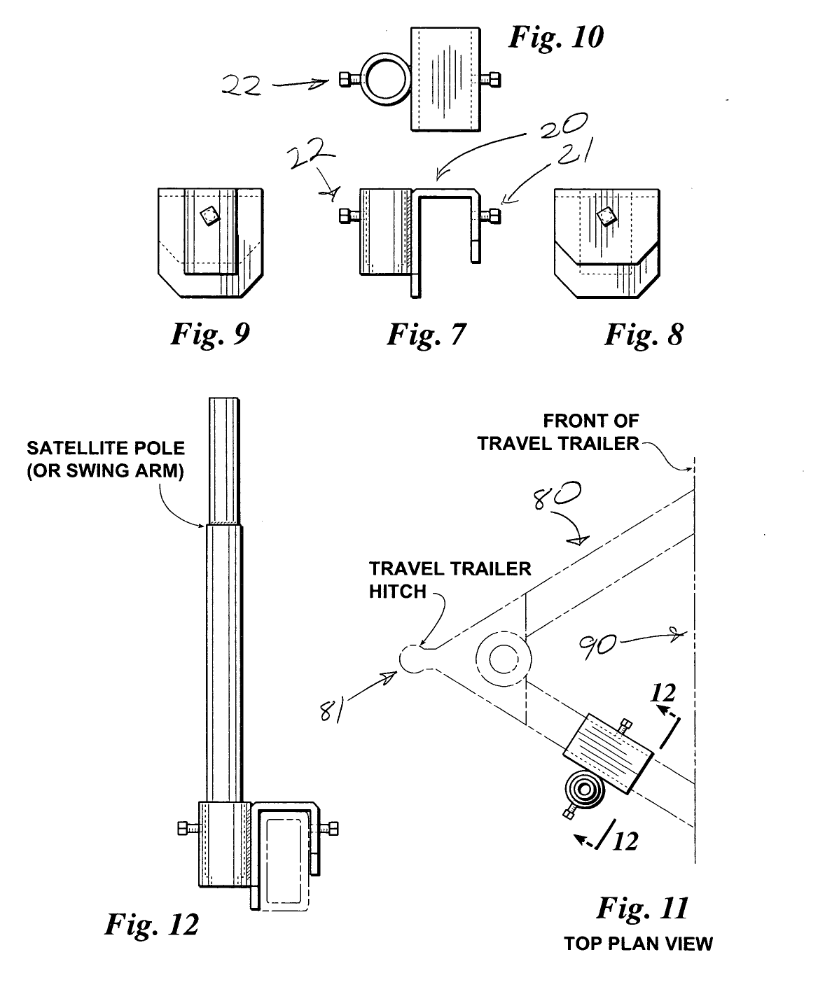

The aforesaid front bracket 20 is designed to mount on the trailer tongue 80 of a RV. The front bracket consists of a U-shaped piece of metal of such dimensions as to slip over the travel trailer tongue. A metal cylinder is welded to the bracket. The front bracket is secured to the trailer tongue by a set screw 21. The swing arm 30 is inserted into the cylinder, and is freely rotatable, the degrees of rotation is dependent on where the front bracket is mounted on the trailer tongue. The swing arm is secured to the front bracket by set screw 22. The front bracket is shown in FIGS. 7 through 12.

The swing arm extension 30 consists of a metal tube approximately 40 inches long with right angle extension at each end. The tube's diameter is approximately is two inches. The near end of the swing arm, the one inserted into the mounting bracket, either front or rear, is of the same diameter as swing arm, the distal end is of a larger diameter, so that the satellite mounting pole 40 can be inserted. The satellite mounting pole is secured to the swing arm by set screw 31.

The satellite mounting pole 40 is a steel tube aproximately 30 inches long and 2 inches in diameter, tapering down to 1.5 inches at the upper end. The lower end is inserted into the distal end of the swing arm extension. The upper end of the satellite mounting pole is inserted into the base of the satellite dish antenna 50.

This device is an adjunct to an operational dish satellite system. It is visualized that video co-axial cables are attached to the dish satellite system receiver and extend to the front travel trailer tongue and to the rear bumper. In addition, the RV is parked in a location, such that a clear view of the Southern sky is available from either the front or rear of the RV.

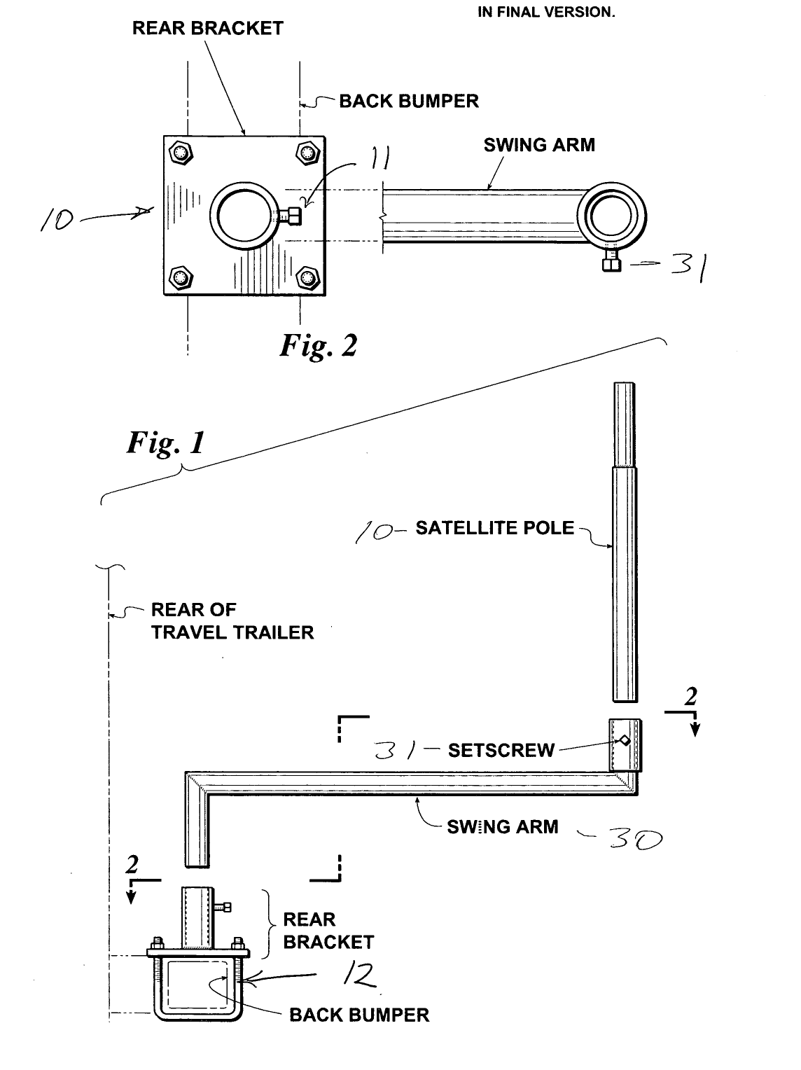

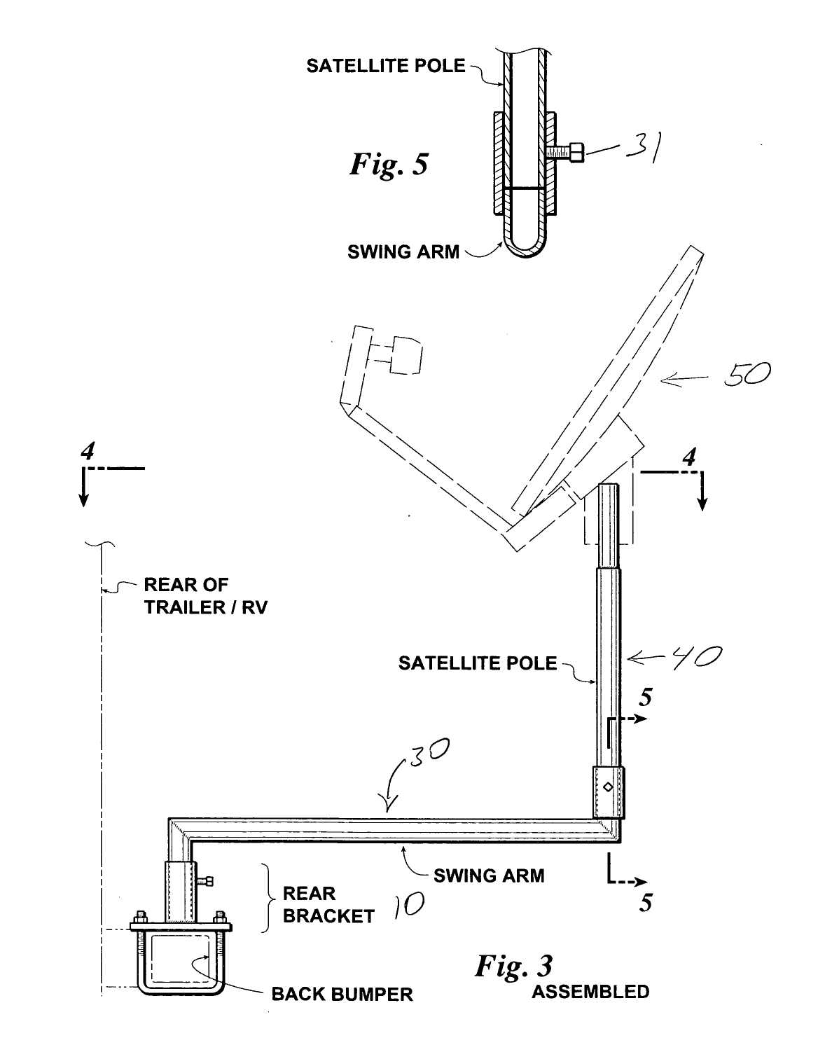

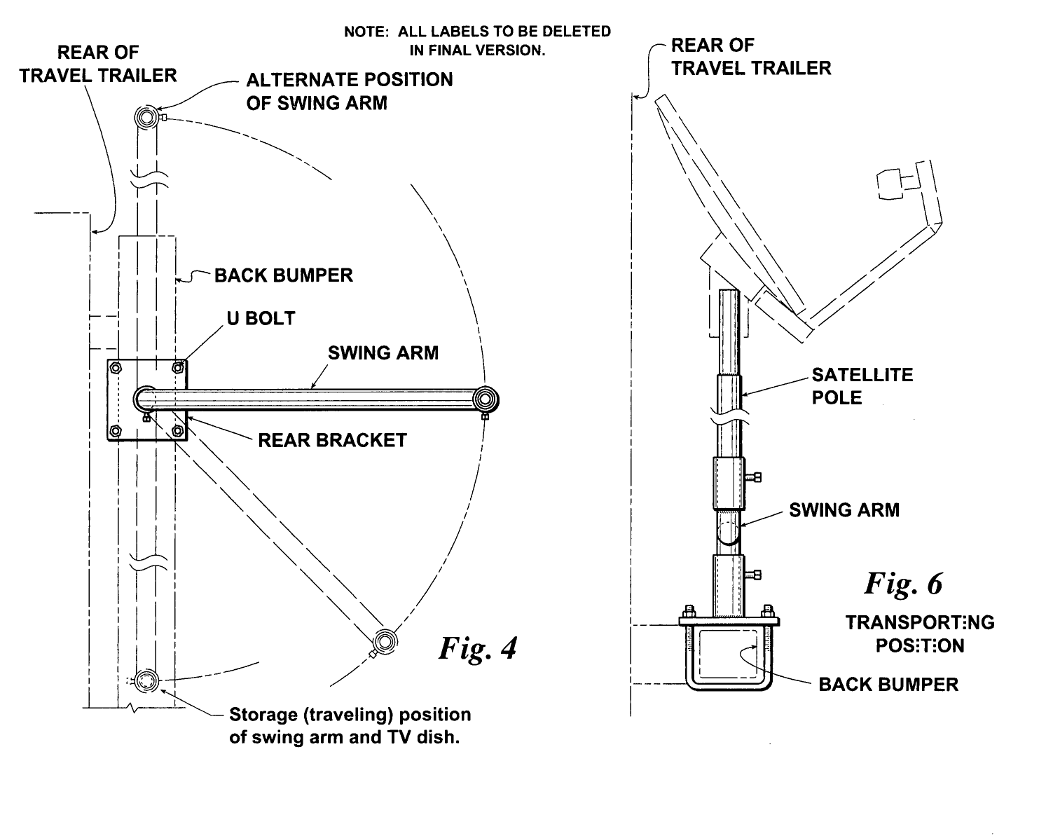

Referring to the drawings, FIGS. 1 through 6, the preferred embodiment of the described device, the swing arm satellite assembly, is as shown. FIG. 1 is a side view of the described device in position on the rear bumper of the RV. FIG. 2 is a top view of the described device with the rear bumper bracket. FIG. 3 side view of the described device, in use, with the rear bumper bracket showing a satellite dish antenna mounted on the satellite mounting pole. FIG. 4 is a top view of the described device mounted on the rear bumper, showing the rotation of swing arm assembly through the full 180°. Note that the preferred transportation mode 100 is shown, in this mode, the dish satellite antenna can be removed, if desired, the set screws 22 and 31 are loosened and the swing arm is rotated as shown, to a position parallel to the rear of the RV, then the set screws 22 and 31 are tightened to secure the device in the transportation mode. FIG. 5 is a cutaway view of the distal end of the swing arm extension 30, showing satellite mounting pole 40 inserted and secured with set screw 31. FIG. 6 shows an side view of the described device in the transportation mode 100, with the dish satellite antenna mounted.

Referring to the drawings, FIGS. 7 through 12, the alternative form of the preferred embodiment of the described device, the swing arm satellite assembly as mounted on the front of the RV, is shown. FIG. 7 through 10 is a series of views of the front bracket, 20, showing the U shape, designed to fit over the travel trailer tongue 80, with set screw 21, which secures the front bracket to the travel trailer tongue, and set screw 22, which secures the swing arm to the front bracket. FIG. 11 is a top view of the described device attached to the front bracket 20, mounted on the travel trailer tongue 80. Note that, depending on the distance from the front bracket 20 to the front of the RV 90, the swing arm 30, may be able to rotate through more than 180°. FIG. 12 is a side view of the described device used the front bracket. Note there is no transportation mode this alternative form.

It is assumed that the operational satellite dish television system exists that has co-axial cable connecting the described device to said system. Said co-axial cables are available for connection of the satellite dish antenna, mounted on the satellite swing arm assembly.

In operation, the rear bumper and front brackets 10 & 20 are secured to the RV as shown, for purposes of demonstration, the rear bumper bracket 10 is used, the swing arm 30 is inserted in the selected bracket, the satellite mounting pole 40 is inserted in the distal end of the swing arm, the dish satellite antenna 50 is mounted on the upper end of the satellite mounting pole. The set screws 11 and 31 are loosened prior to said insertions, so that the device can be assembled. The co-axial cables are connected to the dish satellite antenna. The swing arm is rotated such that a clear view of the southern sky is attained, then the antenna is moved to maximize signal. This can be done either with the assistance of another, who reports on reception, or if alone, by turning the volume of the TV up and listening to the TV as the swing arm and antenna are moved. When the reception is deemed adequate, the set screws 11 and 31 are tightened, securing the antenna in the desired position.

If a clear view the Southern sky is not available from the rear of the vehicle, the front bracket 20 is used. The same procedure as above is followed, except that the set screw 22, is the one securing the swing arm to the bracket.

The advantages of the described device, are (1) the device can be used on the front or rear of the recreational vehicle, allowing enhance television reception (2) the device can be easily transferred from one vehicle to another, (3) the device is easy to install, (4) the device is easy to use, and (5) the device is economical.

1. What is claimed is a device for mounting a dish satellite antenna on a recreational vehicle, further comprising:
a. a bracket for attachment of the device to the recreational vehicle, and,
b. a swing arm extension, and,
c. a satellite mounting pole for attaching the dish satellite antenna to the swing arm extension.

2. The bracket in claim 1 wherein the bracket, designated as the rear bumper bracket, can be attached to rear bumper of the recreational vehicle.

3. The bracket in claim 1, wherein the bracket, designated as the front bracket can be attached to the tongue of the recreational vehicle.
